(19) United States
(12) Patent Application Publication
(10) Pub. No.: US 2009/0153825 A1
(43) Pub. Date: Jun. 18, 2009

(54) LITHOGRAPHIC APPARATUS AND METHOD

(75) Inventors: Remi Daniel Marie EDART, Veldhoven (NL); Franciscus Godefridus Casper Bijnen, Valkenswaard (NL); Rudy Jan Maria Pellens, Overpelt (BE); Pascale Anne Maury, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/273,816

(22) Filed: Nov. 19, 2008

Related U.S. Application Data
(60) Provisional application No. 60/996,507, filed on Nov. 20, 2007.
(60) Provisional application No. 61/004,771, filed on Nov. 30, 2007.

(51) Int. Cl. G03B 27/54; G03B 27/32

(52) U.S. Cl. 355/67; 355/77

(57) ABSTRACT

A lithographic alignment apparatus includes a radiation source arranged to generate radiation at a wavelength of 1000 nanometers or longer, and a plurality of non-imaging detectors arranged to detect the radiation after the radiation has been reflected by an alignment mark.

This application claims priority and benefit under 35 U.S.C. § 119(e) to U.S. Provisional Patent Application Ser. Nos. 60/996,507, filed on Nov. 20, 2007 and 61/004,771, filed on Nov. 30, 2007. The content of these applications are incorporated herein in their entirety by reference.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

In conventional lithography, a series of layers are formed on one side of a substrate which together comprise a plurality of ICs. However, it is sometimes required to provide layers on both sides of the substrate, for example when making MEMs, image sensors and other devices. This may be done by projecting some layers onto a first side of the substrate and then subsequently inverting the substrate in order to project some layers onto the opposite side of the substrate. The layers on opposite sides of the substrate should be aligned with respect to each other in order to ensure that the MEMs devices (or other entities) are properly formed and function correctly. It may be difficult to achieve this alignment.

It is sometimes desired to bond together two substrates upon each of which one or more layers have been provided. This may be the case for example when making MEMs, stacked memories or processor devices. The layers should be aligned with respect to each other, to ensure that the MEMs devices (or other entities) are properly formed and function correctly.

In some cases, it may be difficult to accurately observe the position of an alignment mark which is located on the bottom of a substrate (i.e., on the side of the substrate which is not facing a projection system of a lithographic apparatus). In the case of substrates which are bonded together, it may be difficult to accurately observe the position of an alignment mark which is located between the bonded substrates.

It is desirable to provide a lithographic apparatus or method which obviates or mitigates one or more of the problems of the prior art, whether identified herein or elsewhere.

### SUMMARY

According to a first aspect of embodiments of the invention there is provided a lithographic alignment apparatus comprising a radiation source arranged to generate radiation at a wavelength longer than 1000 nanometers, and a plurality of non-imaging detectors arranged to detect the radiation after the radiation has been reflected by an alignment mark.

According to a second aspect of embodiments of the invention there is provided a method of aligning a substrate in a lithographic apparatus, the method including directing infrared radiation through at least part of substrate and onto an alignment mark, detecting infrared radiation reflected from the alignment mark using a non-imaging detector, and determining the position of the alignment mark using the detected infrared radiation.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts an alignment system according to an embodiment of the invention and a substrate;

FIGS. 3 to 5 depict the alignment system in more detail;

FIG. 6 depicts an diffraction grating alignment mark whose position may be measured using the invention; and

FIGS. 7 to 14 depict an alignment system according to an embodiment of the invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

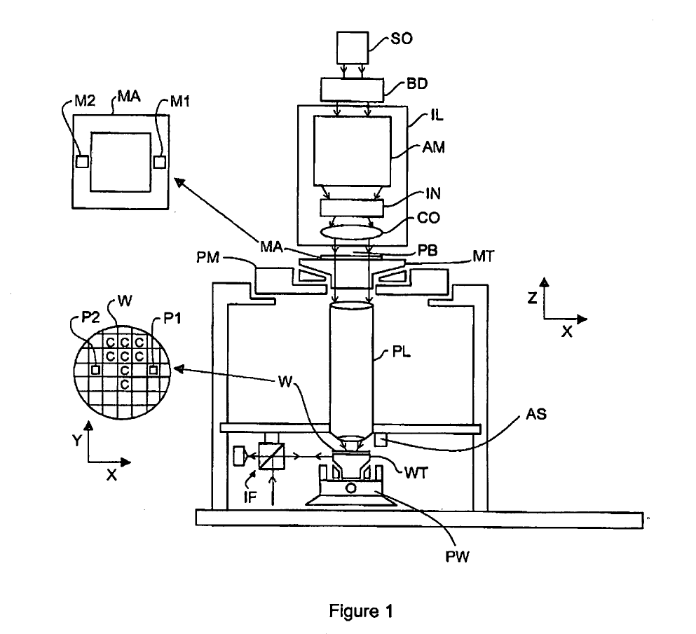

FIG. 1 schematically depicts a lithographic apparatus according to a particular embodiment of the invention. The apparatus comprises:

an illumination system (illuminator) IL to condition a beam PB of radiation (e.g. UV radiation or DUV radiation).

a support structure (e.g. a support structure) MT to support a patterning device (e.g. a mask) MA and connected to first positioning device PM to accurately position the patterning device with respect to item PL;

a substrate table (e.g. a wafer table). WT for holding a substrate (e.g. a resist-coated wafer) W and connected to second positioning device PW for accurately positioning the substrate with respect to item PL; and

a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g., mask) MA, which is held on the support structure MT. Having traversed the patterning device MA, the beam PB passes through the lens PL, which focuses the beam onto a target portion C of the substrate W. With the aid of the second positioning device PW and position sensor IF (e.g., an interferometric device), the substrate table WT can be moved accurately, e.g., so as to position different target portions C in the path of the beam PB. Similarly, the first positioning device PM and another position sensor (which is not explicitly depicted in FIG. 1) can be used to accurately position the patterning device MA with respect to the path of the beam PB, e.g., after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed.

Patterning device MA and substrate W may be aligned using patterning device alignment marks M1, M2 and substrate alignment marks P1, P2. An alignment system AS is provided in the lithographic apparatus adjacent to the projection system PL. The alignment system is arranged to measure the positions of the alignment marks P1, P2, and thereby allow the patterning device MA to be aligned with the substrate W. This ensures that the pattern which is projected onto the substrate W is aligned with patterns already present on the substrate (to within a predetermined margin of error). The alignment system AS is described in more detail further below.

The depicted apparatus can be used in the following preferred modes:

1. In step mode, the support structure MT and the substrate table WT are kept essentially stationary, while an entire pattern imparted to the beam PB is projected onto a target portion C in one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e., a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In conventional lithography, a series of layers are formed on one side of a substrate which together comprise a plurality of ICs. In some instances it may be desired to project some layers onto a first side of the substrate and some layers onto a second side of the substrate. An embodiment of the invention may be used to align layers projected onto the second side of the substrate with layers previously projected onto the first side of the substrate.

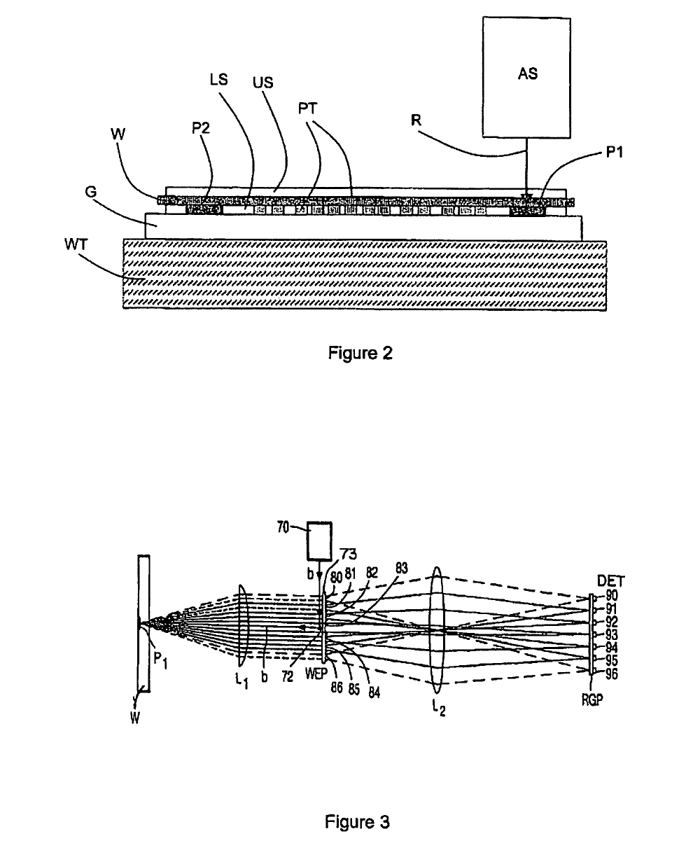

The embodiment of the invention comprises an alignment system which is arranged to measure the position of one or more diffraction grating alignment marks provided on a substrate. The alignment system uses infrared radiation which is capable of passing through the substrate and is therefore capable of viewing alignment marks located on the underneath of the substrate, as shown in FIG. 2. Although some of the infrared radiation may be scattered and/or absorbed by the substrate, the wavelength of the infrared radiation is such that sufficient radiation will be returned to the alignment system after passage through the substrate to allow measurement of the position of the alignment mark.

Referring to FIG. 2, a substrate W mounted on a glass carrier G is held on a substrate table WT. A pattern PT has been provided on a lowermost side LS of the substrate. Two alignment marks P1, P2 have also been provided on the lowermost side of the substrate.

It is desired to project a pattern onto an uppermost side US of the substrate. In order to achieve this, the pattern should be aligned with the alignment marks P1, P2 provided on the lowermost side LS of the substrate W. The alignment system AS emits infrared radiation, which is shown in FIG. 2 as arrow R. The infrared radiation passes through the substrate W and is incident upon the first alignment mark P1. Some of the radiation passes back up through the substrate W and returns to the alignment system AS. The alignment system uses this returned radiation to determine the position of the first alignment mark P1.

Following this, the substrate table WT is moved so that the second alignment mark P2 is located beneath the alignment system AS. The alignment system AS again emits infrared radiation which passes through the substrate W. The radiation is incident upon the second alignment mark P2, and some of the radiation passes back up through the substrate W to the alignment system AS. The alignment system uses the returned radiation to determine the position of the second alignment mark P2.

The positions of additional alignment marks may be determined in the same manner. For example, the alignment system AS may be used to determine the positions of eight alignment marks (not shown) provided in different locations on the substrate W may be determined. In some instances, one or more alignment marks may be associated with each target portion C (see FIG. 1) of the substrate. Where this is the case, the alignment system AS may be used to determine the positions of each alignment mark, or merely some of the alignment marks. It is not essential that the position of every alignment mark provided on the substrate is measured.

Once the positions of a desired number of alignment marks have been measured, the projection system PS (see FIG. 1) is used to project a pattern onto the uppermost surface US of the substrate. The pattern is projected onto target portions C of the substrate. The precise position of each target portion C is calculated by the lithographic apparatus with respect to the measured positions of the alignment marks P1, P2 (and other not illustrated alignment marks) on the lowermost surface LS of the substrate. In this way, alignment of the projected pattern with the pattern PT on the lowermost surface of the substrate is achieved.

An embodiment of the alignment system AS is shown in more detail in FIGS. 3 to 5. The alignment mark P1 comprises a diffraction grating. An alignment beam b having an infrared wavelength is generated by a source 70 (for example a semiconductor laser). The alignment beam b passes through the substrate W and is incident upon the diffraction grating alignment mark P1. The diffraction grating splits up the alignment beam b into a number of sub-beams extending at different angles αₙ (not shown) to the normal of the grating and back through the substrate W. The angles are defined by the known grating formula:

$$Sin {α}_{n} = \frac{N \cdot λ}{P}$$

wherein N is the diffraction order number, λ is the wavelength, and P is the grating period.

The path of the sub-beams reflected by the grating incorporates a lens system L₁ which converts the different directions of the sub-beams into different positions uₙ (not shown) of these sub-beams in a plane 73:

uₙ=f₁·αₙ

in which f₁ is the focal length of the lens system L₁. In this plane optical elements are provided for further separating the different sub-beams. To this end, a plate may be arranged in this plane, which is provided with deflection elements in the form of, for example, wedges 80-86. In FIG. 3, the wedge plate is denoted by WEP. The wedges are provided on, for example, the rear side of the plate.

A beam splitter 72 is provided on the front side of the plate WEP, the beam splitter being arranged to reflect the alignment beam b generated by the source 70 such that it is incident upon the substrate W. The beam splitter 72 may also prevent the 0-order sub-beam from reaching detectors of the alignment system. A λ/4 plate (not shown) may be provided between the beam splitter 72 and the first lens system L1. The beam splitter may be a polarizing beam splitter arranged in combination with the λ/4 plate such that the majority of the alignment beam b is initially reflected by the beam splitter but is then transmitted through the beam splitter once it has been reflected from the substrate W.

The number of wedges 80-86 provided on the wedge plate WEP corresponds to the number of sub-beams which are used to measure the position of the diffraction grating alignment mark P1. In the embodiment shown in FIG. 3 there are six wedges per dimension for the plus orders, so that the sub-beams can be used up to and including the 7^{th}-order to measure the position of the diffraction grating alignment mark P1. Each wedge has a different wedge angle, the angles being selected to provide good separation of the different sub-beams.

A second lens system L₂ is provided behind the wedge plate. This lens system images the mark P₁ in a plane in which a reference plate RGP is present. In the absence of the wedge plate, all sub-beams would be superimposed in the reference plane. However, since the different sub-beams through the wedge plate are deflected at different angles, the images formed by the sub-beams reach different positions in the reference plane. These positions Xₙ (not shown) are given by:

Xₙ=f₂·γₙ

in which f₂ is the focal length of the lens, and γₙ is the angle at which a sub-beam is deflected by the wedge plate WEP.

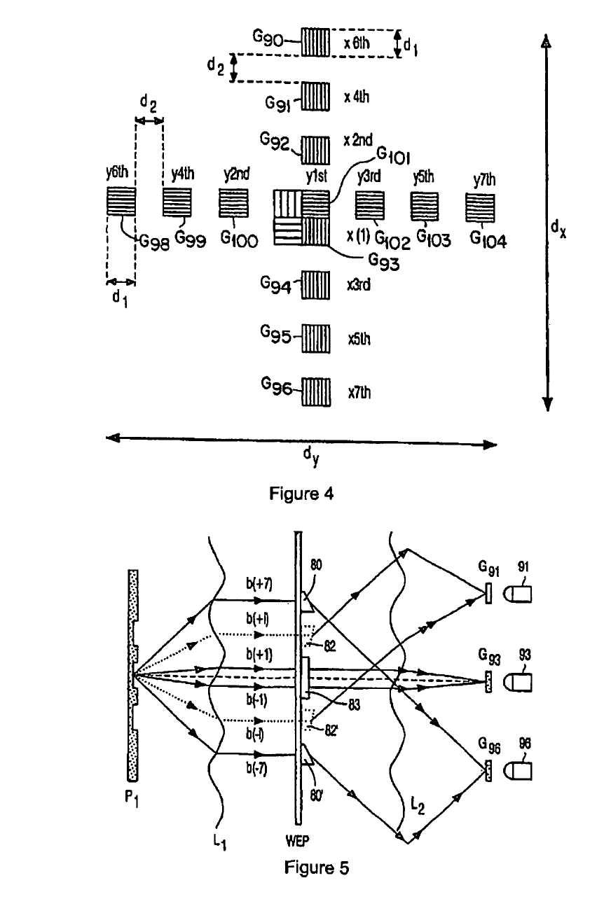

At these positions, reference gratings G₉₀-G₉₆ are provided in the reference plate shown in FIG. 4. A separate detector 90-96 (DET) is located behind each of these reference gratings. The detectors may for example be photodiodes. The output signal of each detector is dependent upon the extent to which the image of the substrate grating P₁ coincides with the relevant reference grating. Hence, the extent of alignment of the substrate grating, and thus of the substrate, can be measured with each detector 90-96. However, the accuracy with which the measurement takes place is dependent on the order number of the sub-beam used. If this order number is larger, the accuracy is greater. In FIG. 4 it has been assumed for the sake of simplicity that all reference gratings G₉₀-G₉₆ have the same grating period. Actually, however, the grating period of each grating is adapted to the order number of the associated sub-beam. As the order number gets larger, the grating period becomes smaller and a smaller alignment error can be detected.

Hitherto only one set of diffraction orders has been considered. As is known, a diffraction grating forms, in addition to +1, +2, +3, etc., order sub-beams, also sub-beams of diffraction orders −1, −2, −3 etc. Both the plus orders and the minus orders sub-beams are to be used to form the grating image, i.e., a first image of the grating mark is formed by the +1 and −1 order sub-beams jointly, a second image is formed by the +2 and −2 order sub-beams jointly, and so forth. For the +1 order and the −1 order sub-beams no wedges need to be used, but plane-parallel plates which compensate for path-length differences can be provided at the positions of these sub-beams in the plane of the wedge plate. Thus six wedges, both for the plus orders and for the minus orders, are used for the orders 2-7.

FIG. 5 illustrates more clearly the functioning of the wedges of the embodiment shown in FIG. 3. In FIG. 5, which is more schematic than FIG. 3, the first lens system L₁ and the second lens system L₂ are represented by wavy lines. For clearness sake only the sub-beams of the first orders b(+1) and b(−1), the sub-beams of the seventh order b(+7) and b(−7) and the sub-beams of another order b(+i) and b(−i), for example the fourth order, are shown. As FIG. 5 illustrates, the wedge angles, i.e., the angle which the inclined face of the wedge makes with the plane surface of the wedge plate WEP, of the wedges 80 and 80′ are such that the sub-beams b(+7) and b(−7) are deflected in parallel directions and converged by the second lens system on one reference grating G₉₆. Also the sub-beams b(+i) and b(−i) are deflected by the associated wedges 82 and 82′ in parallel directions and converged on one reference grating G₉₁. The first order sub-beams are not deflected and are converged by the second lens system on one reference grating G₉₃. By using both the plus order and the minus order of each diffraction order an accurate image of the grating alignment mark P1 is formed on the associated reference grating and maximum use is made of the available radiation. Detectors 91, 93, and 96 are shown behind the reference gratings G₉₁, G₉₃, and G₉₆ respectively. For ease of illustration the radiation is not shown as passing through a substrate before being incident upon the grating alignment mark.

The embodiment of the alignment system described in relation to FIGS. 3 to 5 may include additional features described in U.S. Pat. No. 6,297,876, which is herein incorporated by reference in its entirety.

An example of a diffraction grating alignment mark which may be used as the first and second alignment marks (and other alignment marks) is shown in FIG. 6. The diffraction grating alignment mark may for example be a phase grating. The diffraction grating alignment mark may consist of four sub-gratings P_{1,a}, P_{1,b}, P_{1,c} and P_{1,d}, two of which, P_{1,b} and P_{1,d}, serve for alignment in the x-direction and the two other ones, P_{1,a} and P_{1,c}, serve for alignment in the y-direction. Two of the sub-gratings P_{1,b} and P_{1,c} have a grating period of, for example 16 microns. The other two subs-gratings P_{1,a} and P_{1,d} have a grating period of, for example 17 microns. Each sub-grating may have a dimension of, for example 200×200 microns. By choosing different grating periods, the capture range of the alignment system AS can be enlarged. The capture range for the illustrated diffraction grating alignment mark P1 may for example be 40 microns.

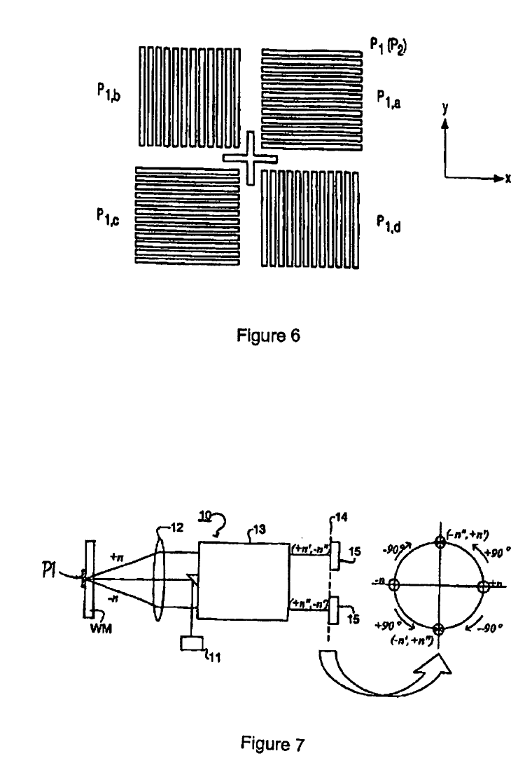

An alternative embodiment of the alignment system is shown schematically in FIGS. 7 to 14. FIG. 7 is an overall schematic of the alignment system 10. A light source 11 emits a spatially coherent beam of infrared radiation. The beam of radiation passes through a substrate W and is incident upon an alignment mark P1 which reflects the radiation into positive and negative diffraction orders +n, −n. These are collimated by objective lens 12 and enter self-referencing interferometer 13. The objective lens 12 may have a high NA, e.g. =0.6. The self-referencing interferometer outputs two images of the input with a relative rotation of 180 degrees and which overlap and can therefore be made to interfere. In a pupil plane 14, the overlapping Fourier transforms of these images, with the different diffraction orders separated can be seen and can be made to interfere. Detectors 15 in the pupil plane detect the interfered diffraction orders to provide positional information, as explained further below. The right-hand part of FIG. 7 shows the formation of the overlapping images—one image +n′, −n′ is rotated by +90 degrees relative to the input orders. +n, −n and the second image +n″, −n″ is rotated by −90 degrees.

The image rotator and interferometer 13 forms the heart of the alignment system and it is shown in FIG. 7 as a white box. A detailed explanation of this part is given below. The alignment system 10 may allow that the phase information in the entire pupil plane 14 is available and can be measured with a suitable detector array 15. A consequence of this is that it provides freedom of alignment mark choice—the alignment system can align on any alignment mark that has substantially a 180 degree rotational symmetry. Indeed, as will be discussed below, a certain amount of asymmetry can be accommodated and detected.

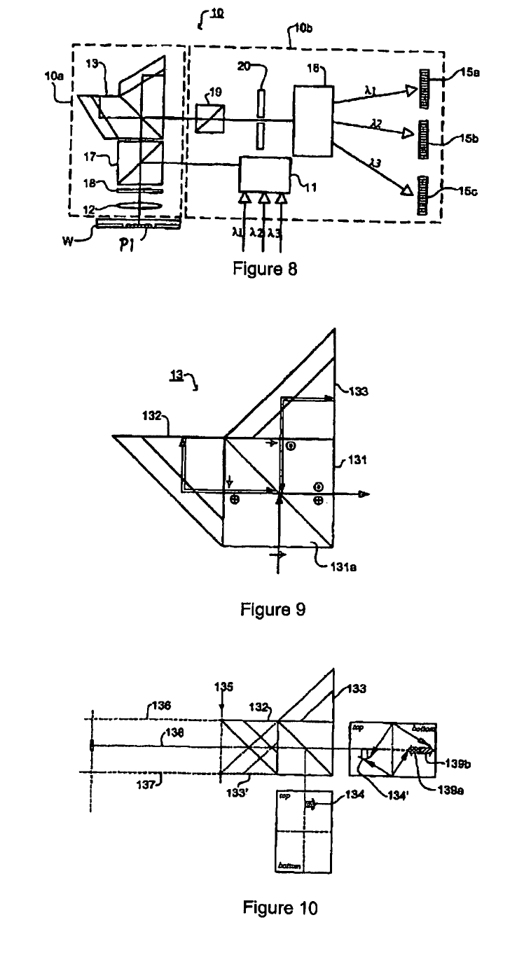

Another feature of an embodiment of the alignment system 10 is its modularity, shown in FIG. 8. The self-referencing interferometer 13 and the objective lens 12 form one compact unit (the front-end 10a) that should be stable. This front-end 10a generates the two overlapping wavefronts that contain the position information. The actual measurement of the phase difference in the pupil plane 14 is done in the back-end 10b of the sensor. This back-end 10b has less tight specifications on stability since the position information is already encoded in the front-end 10a. The non-critical back-end 10b contains the detector configuration 15, the light source multiplexer 11 and a wavelength de-multiplexer 16 to allow use of multiple wavelengths. This configuration determines the functionality that will be available to the end user.

An important advantage is the fact that design changes in the back-end 10b tend to have little impact on the front-end 10a. The front-end 10a needs to be designed only once and may not need any re-design if, for example, a different wavelength or a different grating period is needed.

The front-end 10a contains the interferometer 13, a beam splitter 17 for the illumination beam, a quarter wave plate 18 and the objective lens 12. In place of the beam splitter, it is also possible to use an angled plane plate with a small central silvered area to reflect the illumination beam onto the alignment mark. The back-end 10b may be embodied in various different forms but essentially contains components to perform the following functions: a polarizer 19 to create the interference pattern (the overlapping beams are orthogonally polarized); an aperture stop 20 to prevent product cross talk; a wavelength de-multiplexer 16 to split the various wavelengths on the detector side; and a detector array 15a-15b. As is explained below, the shape of the aperture stop may also be selected to avoid cross-talk between orders.

The availability of the entire pupil plane and the modularity of the back-end can allow the construction of a flexible alignment sensor. As necessary or useful, new functions can be added with a relatively small design effort and the sensor can be made compatible with other alignment sensors at the application level, allowing users to continue to use processes, including masks and machine settings, developed for apparatus using other alignment sensors.

The self-referencing interferometer 13 achieves interference of opposite overlapping diffraction orders. Drift or instability of this interferometer may degrade the alignment accuracy. The interferometer 13 is shown in FIG. 9, a side view, and consists of three main parts: a polarizing beam splitter (PBS) 131 to split and recombine an incoming wavefront; and two prisms 132, 133 which reflect and rotate an incoming wavefront over 90 degrees. The reflected and rotated wavefronts are also laterally displaced. Moreover the polarization is rotated over 90 degrees. To minimize drift, the interferometer 13 is made of solid glass and the separate parts 131, 132, 133 are glued together. In practice, the interferometer 13 may be made from two solid glass parts, each comprising one of the prisms 132, 133 and half of the beam splitter 131, which are glued together along the reflecting plane 131a of the beam splitter 131.

The solid-headed arrows in FIG. 9 show the ray trace of a single beam of the incident wavefront while the open-headed arrows indicate the orientation of an incident wavefront and not the plane of polarization. Following the ray trace and the orientation of the wavefront shows that both prisms rotate the wavefront over 90 degrees in the clockwise direction. The two recombined wavefronts have obtained a net 180 degrees rotation relative to each other and are orthogonally plane polarized.

Further details of the operation of the rotation prisms can be found in EP-A-1148390. It can be shown that the prisms can be modeled as optical elements that mirror and rotate any incoming beam.

To explain the operation of the interferometer, FIG. 10 shows a rectangular input plane with an arrow-shaped object 134 that enters the interferometer 13. The input object 134 is split by the beam splitter 131 and enters the two rotation prisms 132, 133. For convenience, the second rotation prism 133 is also shown mirrored in the beam splitter plane in phantom 133′. This approach simplifies the explanation since we have now two overlapping interferometer branches: a ‘real’ one with the first prism and a ‘virtual’ branch with the second prism.

Due to the symmetry of the interferometer 13, the virtual mirror planes 135 of both prisms 132, 133 coincide. However, the rotation axes 136, 137 of the two prisms are at opposite sides of the center line 138 of the interferometer 13. The virtual mirror plane 135 creates a virtual image 134′ of the input object 134. The mirrored image 134′ is shown as an open arrow in the figure. This image, however, is only shown here for convenience and is in reality not present because of the additional rotation of the two prisms.

The two rotation axes 136, 137 are placed at opposite sides of the center of the interferometer branches. As a result, the image is rotated in opposite directions The +90 degrees rotation and −90 degrees rotation result in, respectively, cross-hatched and diagonal hatched arrows 139a, 139b. The two arrows face in opposite directions (so the net rotation is indeed 180 degrees) and the feet of the arrows are connected which indicates that the location of the feet is an invariant point of the interferometer.

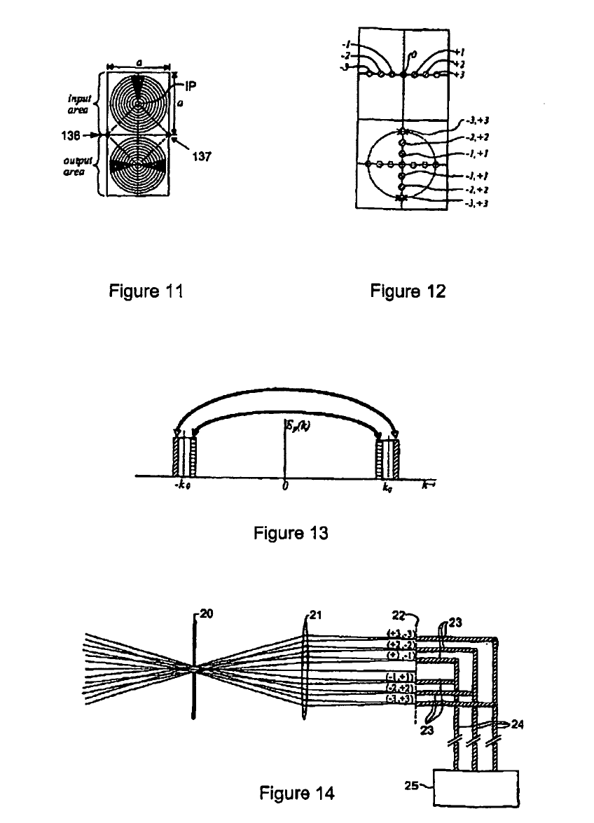

FIG. 11 shows a graphical construction of the invariant point. The interferometer has a rectangular input and output plane of width a and height 2a. The field entering the interferometer occupies the top half of the interferometer (input area) and is mirrored downward over the center of symmetry and rotated over +90 degrees and −90 degrees by the two prisms. These overlapping fields are present in the output area. The rotation axes are separated by a distance a as shown in the figure. It can be readily verified graphically that the invariant point IP is the exact center of the input area.

Concentric circles around the invariant point IP are imaged onto themselves with a relative rotation of 180 degrees. as indicated by the cross- and diagonally-hatched slices. The benefit of the lateral displacement over a distance a of the input and the output is the fact that optical feedback into the alignment radiation source (e.g. a laser) is prevented.

It is now easy to see how overlapping diffraction orders are generated with this interferometer. The 0-order is projected on the rotation invariant point and the even and odd diffraction orders rotate around this point as shown in FIG. 12.

The alignment system 10 requires a spatially coherent light source, preferably a laser since thermal and gas-discharge light sources can only be made spatially coherent by throwing away a lot of light. To avoid some interference problems it may be useful to use light with a short temporal coherence.

Accordingly, the preferred light source 11 is a laser diode as such diodes are spatially coherent and their coherence length can be easily spoiled by applying an RF modulation to the injection current. The laser diode generates infrared radiation. Alternatively, the laser may for example be a Nd:YAG laser with a phase modulator (see EP-A-1 026 550), or may be a fiber laser.

The design of the illumination optics is driven by two conflicting requirements. In order to maximize the signal strength and minimize product crosstalk a small spot is desired that illuminates only the alignment mark. On the other hand, a small spot complicates the capturing process. Moreover, the alignment accuracy is more affected by spot position variations.

Product crosstalk can be effectively suppressed with aperture stops and with the availability of high-power lasers, alignment performance is rarely limited by signal strength. For this reason, the illumination spot size is at least larger than the size the alignment mark. Assuming an alignment mark size of the order of 50×50 microns and a required capturing range of the same order, a spot diameter of the order of 100 microns is suitable.

In the alignment system 10, the illumination spot is circularly polarized to enable illumination and detection light to be separated with the aid of polarizing beam splitter 17 and a 0-order quarter wave plate 18 as shown in FIG. 8.

For coarse alignment mark gratings with a pitch much greater than the wavelength of the illumination beam, the choice of polarization is not very important. However, where the pitch of the alignment mark grating is of the same order as the wavelength, the diffraction efficiency depends on the polarization, and in the extreme case, the alignment mark can acts as a polarizer that diffracts only one polarization component. For such alignment marks, circularly polarized light is advantageous. In the case of linearly polarized light there is always a chance that the efficiency of a grating is very low for one particular orientation. Circularly polarized light contains two orthogonally polarized components (with a 90 degree phase shift) so there is always one component that will efficiently diffract the light.

In order to suppress spurious reflections it is possible to apply a minor tilt to the polarizing beam splitter 17 and the quarter wave plate 18. The tilt angle should be chosen carefully to minimize aberrations that are introduced by this tilt. Of course, it is also possible to correct for such aberrations in the design of the objective lens.

The interferometer produces two orthogonally polarized (virtual) images of the pupil E(k) where k is a spatial frequency. The total optical field in the pupil plane 14 is the original field plus a 180 degrees rotated copy of this field. The intensity in the pupil plane is:

I(k,x₀)=|Eₚ(k,x₀)+Eₚ(−k,x₀)|²

If two detectors 15 with a width 2Δk are placed at positions k=k₀ and k=−k₀ in the pupil plane 14, the optical powers P₁ and P₂ captured by these detectors are given by:

$${P}_{1} ( {x}_{0} ) = {\int }_{- {k}_{o} - Δ k}^{- {k}_{0} + Δ k} \vert {{E}_{p} ( k , {x}_{o} \vert}^{2} d k + {\int }_{- {k}_{o} - Δ k}^{- {k}_{0} + Δ k} {\vert {E}_{p} ( - k , {x}_{o} ) \vert}^{2} d k + {\int }_{- {k}_{o} - Δ k}^{- {k}_{0} + Δ k} {E}_{p} ( k , {x}_{o} ) {E}_{p}^{*} ( - k , {x}_{o} ) d k + {\int }_{- {k}_{o} - Δ k}^{- {k}_{o} + Δ k} {E}_{p}^{*} ( k , {x}_{0} ) {E}_{p} ( - k , {x}_{o} ) d k \\ and \\ {P}_{2} ( {x}_{0} ) = {\int }_{- {k}_{o} - Δ k}^{- {k}_{0} + Δ k} \vert {{E}_{p} ( k , {x}_{o} \vert}^{2} d k + {\int }_{- {k}_{o} - Δ k}^{- {k}_{0} + Δ k} {\vert {E}_{p} ( - k , {x}_{o} ) \vert}^{2} d k + {\int }_{- {k}_{o} - Δ k}^{- {k}_{o} + Δ k} {E}_{p} ( k , {x}_{o} ) {E}_{p}^{*} ( - k , {x}_{o} ) d k + {\int }_{- {k}_{o} - Δ k}^{- {k}_{o} + Δ k} {E}_{p}^{*} ( k , {x}_{0} ) {E}_{p} ( - k , {x}_{o} ) d k$$

FIG. 13 shows the signal formation graphically. Because of the mirror operation, the horizontally hatched areas overlap and interfere and the diagonally hatched areas overlap and interfere. The phase difference between the two fields contains the position information.

The two images of the pupil are orthogonally and linearly polarized and interference between them is therefore not visible in the form of intensity variations (fringes). In order to translate phase variations into intensity variations, the two images of the pupil must have the same polarization. This is realized with a polarizing optical element, which may be a dichroic sheet polarizer, a regular polarizing beam splitter based on a multi-layer coating, or a birefringent beam splitter such as a Savart plate, a Wollaston Prism, a Glan-Taylor beam splitter or a “wire grid” polariser.

Dichroic sheet polarizers are not preferred because of their limited optical quality and they are often less effective for infrared radiation. Moreover, these sheet polarizers throw away 50% of the photons. A multi-layer beam splitter is far better but the wavelength range over which a good extinction ratio is achieved maybe limited. Birefringent beam-splitters have excellent extinction ratios over a large wavelength range but the birefringence may lead to temperature drift since the birefringence is temperature dependent.

If a beam splitter is used as polarizer 19, the field incident on it has a Jones vector:

$$j = ( \begin{matrix}E ( k ) \\ E ( - k )\end{matrix} )$$

The polarizing beam splitter is oriented at 45 degrees relative to the orientation of E(k) and E(−k) so the intensities that are transmitted, I₁(k), and coupled out, I₂(k), by the beam splitter are:

$${I}_{1} ( k ) = \frac{1}{2} \vert {E ( k )}^{2} \vert + \frac{1}{2} \vert {E ( - k )}^{2} \vert + \vert E ( k ) \vert \vert E ( - k ) \vert cos ( φ ( k ) - φ ( - k ) )$$

$$and$$

$${I}_{2} ( k ) = \frac{1}{2} \vert {E ( k )}^{2} \vert + \frac{1}{2} \vert {E ( - k )}^{2} \vert + \vert E ( k ) \vert \vert E ( - k ) \vert cos ( φ ( k ) - φ ( - k ) )$$

As can be seen, the two intensities vary in anti-phase and the total intensity equals the intensity that is incident on the beam splitter. Thus, both branches contain position information and can be used for alignment. This means that it is possible to use one branch for x-position detection and the other for y-position detection, allowing use of rectangular aperture stops to avoid product crosstalk. Alternatively, one branch can be used with a small aperture stop for fine alignment and the other branch with a large aperture stop for capturing. A further alternative is to use one branch for one set of wavelengths and the other branch for another set of wavelengths.

Alignment marks are often placed in the scribe lane very close to product structures which may lead to product cross-talk: light scattered by the product influences the alignment signal. Product cross-talk can be strongly attenuated by using a sufficiently small illumination beam. However, a small illumination beam is not preferred for various reasons. With a small illumination beam, the stability of the position of the illumination spot becomes more critical. For example, in the extreme case of a scanning spot, drift in the illumination spot results directly in alignment position drift. Also, capturing becomes more critical since there is a greater chance that the alignment mark is very poorly illuminated. Finally, a greater illumination NA is needed which makes the detection of coarse gratings more demanding.

For these reasons it is desirable to use a large illumination spot, for example with a 1/e² width of roughly three times the maximum alignment mark diameter. The consequences of such a large spot are that product structures are illuminated and that the optical power on the alignment mark decreases. However, the latter item is not a serious problem since a sufficiently powerful radiation source can be provided.

The detection array 15 is placed in a pupil plane, preferably the pupil plane 22 after the aperture stop 20. The simplest detector configuration is shown in FIG. 14. For simplicity only the lowest 3 orders and one wavelength is shown. Moreover, the zero order is not shown either. Two multimode detection fibers 23 collect the light from each order. The light leaving these two fibers can be coupled into one multimode fiber 24 and sent to remote detectors 25. The detectors may for example be photodiodes.

This approach is simple and provides functionality compatible with a known sensor. However, extra functionality can easily be added by providing an extra wavelength output or extra orders since the NA of the objective lens 12 can be high.

In order to be more flexible towards alignment mark pitches or allow the measurement of non-periodic alignment marks such as boxes or frames a detector array can be used. This detector array also allows the possibility of accurate asymmetry detection as discussed below. For the detector array, a number of options are possible: a bundle of multimode fibers, and/or discrete photodiodes (e.g. PIN detectors) per channel.

The use of a bundle of multimode fibers enables any dissipating elements to be remotely located for stability reasons. Discrete PIN detectors offer a large dynamic range but each need separate pre-amps. The number of elements is therefore limited.

If two-dimensional data acquisition is needed for maximum flexibility then massive parallelism is required, increasing the complexity of the electronics. A great deal of flexibility is possible if the data acquisition is restricted to two orthogonal directions so that linear detector arrays can be used.

Further details regarding this embodiment of the invention are set out in U.S. Pat. No. 6,961,116 which is herein incorporated by reference in its entirety.

The wavelengths used by the alignment systems are in the infrared, and are sufficiently long that sufficient radiation passes through the substrate to allow the alignment marks P1, P2 to be seen by the alignment system AS. Suitable infrared wavelengths may be 1000 nanometers or longer. Silicon becomes substantially transparent at around 1000 nanometers. The wavelength may be for example up to 6 microns, up to 8 microns, or even up to 10 microns.

The wavelength may be for example be 1064 nanometers (e.g., generated using a Nd:YAG laser). The wavelength may for example or 1130 nm (e.g., generated using a Ti:Sapphire laser). If a wavelength is used which undergoes significant absorption in silicon, the substrate should be sufficiently thin that absorption of the radiation by the substrate does not prevent the alignment marks P1, P2 being seen by the alignment system

The wavelength may for example be 1640 nanometers (e.g., generated using a Er:YAG laser).

As mentioned above, the wavelength which is used by the alignment system AS may depend upon the thickness of the substrate through which the radiation must pass in order to be incident upon the alignment marks. For example, in some instances the substrate is ground down such that the thickness of the substrate is thinner than a conventional substrate. A typical silicon substrate has a thickness of between 500 and 750 microns. The thickness depends on the diameter of the substrate (which is often referred to as a wafer). Where a substrate having a conventional thickness is used, it may be desired to use a wavelength which has negligible absorption in silicon in order to ensure that absorption of the radiation by the substrate does not prevent the alignment marks P1, P2 being seen by the alignment system.

In some instances the substrate is ground down until it has a thickness of a few tens of microns (and possibly even a few microns). For example, the substrate may be ground down to 50 microns thickness, or may be ground down to 20 microns thickness. Where a ground down substrate is used, it may be possible to use a wavelength which undergoes some absorption in silicon, provided that absorption of the radiation by the substrate does not prevent the alignment marks. P1, P2 being seen by the alignment system.

The alignment system may include a plurality of sources arranged to generate radiation at different wavelengths (or a tunable source). Multiplexed detection may be used to detect the radiation at different wavelengths, as described above. One or more wavelengths of radiation used for alignment may for example be selected based upon prior knowledge of the thickness of silicon through which the radiation must pass in order for alignment to be achieved. Alternatively, a plurality of wavelengths may be used for an initial measurement, and one or more wavelengths which are found to provide the best quality signal may be selected for alignment measurements. This selection may be performed automatically, for example by a control system which monitors the quality of the detected signals.

The above embodiments of the invention have been described in relation to alignment measurements in a lithographic apparatus which are used to align a pattern to be projected with respect to a pattern provided on the underneath of the substrate. However, the invention may also be used to measure the position of a pattern on an upper surface of a substrate with respect to a pattern on a lower surface of the substrate after the pattern has been projected (this is often referred to as overlay).

The overlay may be measured for example by using the embodiment of the invention to measure the positions of alignment marks provided on the lowermost surface of the substrate, and then using the embodiment of the invention to measure the positions of alignment marks provided on the uppermost surface of the substrate. Where this is done, it may be desirable to stagger the positions of the alignment marks, such that if the patterns (and associated alignment marks) are perfectly positioned then the alignment marks are separated such that they do not overlap with one another and are thus visible to the alignment system.

The invention may also be used to measure the accuracy with which two substrates have been bonded together. Each of the substrates may have been provided with alignment marks on a patterned surface. The patterned surfaces may be bonded together, with the result that the alignment marks are in the centre of the bonded structure. The invention may be used to measure the positions of the alignment marks, since the radiation used by the alignment system is capable of passing through the silicon of the upwardly facing substrate to allow the alignment marks in the middle of the structure to be viewed by the alignment system. The invention may be used in a substrate bonding tool during bonding of substrates to align the substrates with respect to one another.

Where the invention is used to measure overlay, the alignment system may be provided in a metrology tool (i.e. a tool which does not include an illumination system IL or projection system PL).

The alignment marks may be of any suitable form, and are not limited to the form shown in FIG. 6. For example, the alignment marks may comprise diffraction gratings provided in scribe lanes between target portions, known as scribe lane alignment marks. The scribe lane alignment marks may for example comprise one or more diffraction gratings which extend along part of the scribe lanes.

The alignment marks may include sub-structure arranged to generate additional diffraction orders.

The alignment marks may be of a form which is measurable in the same manner irrespective of which way up the substrate is facing. That is to say, the alignment marks may be symmetrical such that they appear to have the same form irrespective of from which side of the substrate they are viewed.

A metal layer, for example a layer of Aluminum or Copper, may be located beneath the alignment marks. Where this is done, the metal layer may act to reflect radiation which has passed through the alignment marks, thereby increasing the intensity of radiation incident upon the detector. Referring to FIG. 2, the metal layer may for example be provided over the entire lowermost side LS. This may for example be done as part of back end of the line processing of the substrate. Alternatively, the metal layer may be provided only over the alignment marks P1, P2. The term ‘over’ in the context of FIG. 2 means that the metal layer is beneath, since the lowermost side LS is facing downwards.

In some instances dopants implanted into the silicon substrate during processing may increase the degree to which infrared radiation is scattered by the substrate. One way in which this problem may be addressed is by keeping resist on top of the alignment marks when implantation of a dopant is taking place. This will inhibit dopant from entering the silicon in the vicinity of the alignment marks. Keeping the resist on top of the alignment marks may be achieved by making an appropriate modification to the patterning device MA (a pattering device is shown in FIG. 1). For example, the patterning device may be arranged such that areas over the alignment marks are not exposed to the projected radiation beam during lithography, or so that they are exposed during lithography (depending upon whether the resist is negative resist or positive resist).

Although embodiments of the invention have been described with specific detectors, the invention may use any non-imaging infrared detector. For example, the invention may use a photodiode, which may be formed from GaAs.

An aspect of some embodiments of the invention is that it may allow detection of alignment marks through silicon via infrared radiation, without requiring the use of an imaging detector. Imaging detectors which are capable of detecting infrared radiation of a wavelength which may pass through silicon are expensive, whereas non-imaging detectors are substantially cheaper.

In the above description the substrate 100 has been described as being formed from GaAs or Si. However, it will be appreciated that the substrate may be formed from other suitable materials.

The alignment system AS uses infrared radiation which has a wavelength such that it is capable of penetrating through the material of the substrate to a sufficient extent that it allows alignment marks 104 provided on a lower surface of the substrate to be observed.

Although the alignment system AS is shown in FIG. 1 as being adjacent to the projection system PL, it is not essential that the alignment system be provided in this location. The alignment system may be provided in any suitable location in the lithographic apparatus. For example, in a so called dual stage lithographic apparatus, the alignment system may be some distance away from the projection system.

While specific embodiments of the invention have been described above, it will be appreciated that the invention may be practiced otherwise than as described. The description is not intended to limit the invention.

1. A lithographic alignment apparatus comprising a radiation source arranged to generate radiation at a wavelength longer than 1000 nanometers, and a plurality of non-imaging detectors arranged to detect the radiation after the radiation has been reflected by an alignment mark.

2. The lithographic alignment apparatus of claim 1, wherein the radiation source is arranged to generate radiation at a wavelength shorter than 10 microns.

3. The lithographic alignment apparatus of claim 2, wherein the radiation source is arranged to generate radiation at a wavelength shorter than 8 microns.

4. The lithographic alignment apparatus of claim 1, wherein at least some of the detectors have gratings located in front of them, at least some of the gratings having different grating periods.

5. The lithographic alignment apparatus of claim 1, wherein the apparatus further comprises an image rotator and an interferometer, and at least some of the detectors are located in a pupil plane of the alignment system.

6. The lithographic alignment apparatus of claim 1, wherein the radiation source is one of a plurality of radiation sources arranged to generate radiation at different wavelengths.

7. The lithographic alignment apparatus of claim 1, wherein the apparatus further comprises a multiplexer and a de-multiplexer arranged to allow the generation and detection of multiplexed infrared radiation.

8. The lithographic alignment apparatus of claim 1, wherein the apparatus further comprises a control system arranged to monitor the quality of the detected radiation, and to select one or more infrared radiation wavelengths to be used during measurement of the position of the alignment mark.

9. The lithographic alignment apparatus of claim 1, wherein the lithographic alignment apparatus forms part of a lithographic projection apparatus.

10. The lithographic alignment apparatus of claim 1, wherein the lithographic alignment apparatus forms part of a lithographic overlay measurement apparatus.

11. A method of aligning a substrate in a lithographic apparatus, the method comprising directing infrared radiation through at least part of substrate and onto an alignment mark, detecting infrared radiation reflected from the alignment mark using a non-imaging detector, and determining the position of the alignment mark using the detected infrared radiation.

12. The method of claim 11, wherein the infrared radiation has a wavelength longer than 1000 nanometers.

13. The method of claim 12, wherein the infrared radiation has a wavelength shorter than 10 microns.

14. The method of claim 11, wherein the infrared radiation has a wavelength shorter than 8 microns.

15. The method of claim 11, wherein the infrared radiation which is directed through the substrate has a plurality of different wavelengths.

16. The method of claim 15, wherein the plurality of different wavelengths are multiplexed, and the detection of the radiation is also multiplexed.

17. The method of claim 15, wherein a control system monitors the quality of the detected radiation, and selects one or more infrared radiation wavelengths to be used during measurement of the position of the alignment mark.

18. The method of claim 11, wherein a layer of metal is provided beneath the alignment mark.

19. The method of claim 11, wherein the alignment mark is located on a lowermost side of the substrate.

20. The method of claim 11, wherein the substrate is one of a pair of substrates bonded together, and the alignment mark is located between the substrates.
